(19) United States
(12) Patent Application Publication
(10) Pub. No.: US 2013/0215358 A1
(43) Pub. Date: Aug. 22, 2013

(54) SECURING DEVICE OF LIQUID CRYSTAL PANEL AND LIQUID CRYSTAL DISPLAY USING THE SAME

(71) Applicant: Gang Yu, Shenzhen (CN)

(72) Inventor: Gang Yu, Shenzhen (CN)

(21) Appl. No.: 13/508,514

(22) PCT Filed: Apr. 1, 2012
(86) PCT No.: PCT/CN2012/073467

§ 371 Date: May 7, 2012

(30) Foreign Application Priority Data
Feb. 17, 2012 (CN) 201210036995.8

(51) Int. Cl. G02F 1/1333

(52) U.S. Cl. 349/58

(57) ABSTRACT

A liquid crystal display comprises a liquid crystal panel including a front side and a back side disposed oppositely to the front side; a positioning bump connected with the front side; a middle frame, wherein a supporting portion is extended from an inner side of the middle frame, an upper part of the supporting portion is used for supporting the liquid crystal panel and is connected with the back side of the liquid crystal panel, the rear frame is disposed on the inner side of the middle frame and under the supporting portion; a front frame comprising a positioning hole, wherein the front frame is disposed on an outer side of the middle frame, the positioning bump is inserted into the positioning hole; and an optical element disposing between an inner side of the rear frame and the supporting portion.

### FIELD OF THE INVENTION

The present invention relates to a securing device of a liquid crystal panel and a liquid crystal display using the same and more particularly to a securing device of a liquid crystal panel with a narrow frame and a liquid crystal display using the same.

### BACKGROUND

In the recent years, liquid crystal display (LCD) is widely employed in various electronic products such as laptop computer, digital camera and mobile phone, etc. because of its low power consumption and slim design. In order to enhance the innovative design of LCD, the frame outside the displaying area of a LCD is becoming narrower. In order to achieve the narrow frame design, the screws used for fixing are disposed on the lateral sides of the LCD.

U.S. Pat. No. 7,576,976 discloses an assembling structure of a liquid crystal display. As shown in FIG. 1, a liquid crystal display 8 comprises a liquid crystal display panel 810, a light guide plate 830, a reflective film 831, a rear frame 840, a middle frame 820, a front frame 870, an outer casing 880 and a screw 890.

The middle frame 820 and the reflective film 831 are disposed on the rear frame 840. The middle frame 820 has an extending portion. The light guide plate 830 is disposed between the extending portion and the reflective film 831 so that the light guide plate 830 and the reflective film 831 are fixed by the rear frame 840 and the middle frame 820 and will not shake. The liquid crystal display panel 810 is disposed on the extending portion of the middle frame 820, and the liquid crystal display panel 810 is kept away from the light guide plate 830 at a certain distance. The extending portion of the middle frame 820 supports the liquid crystal display panel 810. A screwing portion 860 is protruded outwardly from a lateral side 841 of the rear frame 840. A screw thread 850 is disposed on an inner side of the screwing portion 860. The front frame 870 is disposed on the lateral side 841 of the rear frame 840. The screw 890 is coordinated with the outer casing 880 and is inserted in the screwing portion 860 for securing the rear frame 840 and the front frame 870. Thereby, the liquid crystal display panel 810 is fixed.

Even though this type of locking and securing structural design meets the requirement of narrow frame design (i.e. the narrower is more desirable for the frame of a liquid crystal display), in the assembling, an operator has to rotate the LCD to have a side facing oneself in order to have the screw locked after the screw is screwed on another side. Therefore, this structural design is not favorable for assembling and enhancing the manufacturing efficiency.

FIG. 2 is an assembling structure of another liquid crystal display disclosed in a conventional technique. A liquid crystal display 9 comprises a liquid crystal panel 910, a front frame 920, a middle frame 930, rear frame 940 and an optical element 950.

The middle frame 930 is disposed on an inner side of the front frame 920. A supporting portion 931 is extended from an inner side of the middle frame 930. The liquid crystal panel 910 is disposed between the front frame 920 and the supporting portion 931. The liquid crystal panel 910 is fixed by the front frame 920 and the supporting portion 931. The rear frame 940 is disposed on the inner side of the middle frame 930 and under the supporting portion 931. The optical element 950 is disposed between the supporting portion 931 of the middle frame 930 and the rear frame 940. The optical element 950 includes a reflective film, a light guide plate, a diffuser film, a prism film, a brightness enhancement film and so on.

Even though the assembling structure of the liquid crystal display 9 is favorable for assembling and enhancing the manufacturing efficiency, the requirement for narrow frame design can not be achieved because the liquid crystal panel 910 has to be fixed by the front frame 920 and the supporting portion 931. The contact area between the front frame 920 and the liquid crystal panel 910 is an area L shown in FIG. 2. The area L has to have a certain length in order to hold the liquid crystal panel 910 securely. The contact area between the front frame 920 and the liquid crystal panel 910 will be too small if the area L is too short, and the liquid crystal panel 910 will be easily detached from the front frame 920. Therefore, the requirement for narrow frame design can not be met.

Therefore, a liquid crystal display which is convenient for assembling and can meet the requirement of narrow frame design is required.

### SUMMARY OF THE INVENTION

An object of the present invention is to provide a securing structure of a liquid crystal panel with a narrow frame and a liquid crystal display using the securing structure.

In order to achieve the above object, a liquid crystal display is provided by the present invention which comprises a liquid crystal panel, a front frame, a middle frame, a rear frame, an optical element and a positioning bump. The liquid crystal panel comprises a front side and a back side disposed oppositely to the front side. The positioning bump is connected with the front side of the liquid crystal panel by an adhesive material, wherein the adhesive material is a heat-fusing adhesive. A supporting portion is extended from an inner side of the middle frame. An upper part of the supporting portion is used for supporting the liquid crystal panel and is connected with the back side of the liquid crystal panel. The rear frame is disposed on the inner side of the middle frame and under the supporting portion. The front frame comprises a positioning hole and the front frame is disposed on an outer side of the middle frame. The positioning bump is inserted into the positioning hole of the front frame. And the optical element is disposed between an inner side of the rear frame and the supporting portion, wherein the optical element is composed of a reflective film, a light guide plate, a diffuser, a prism and a brightness enhancement film.

A technique employed by the present invention to achieve the above object is to insert the positioning bump on the front side of the liquid crystal panel into the positioning hole of the front frame. Thereby, the object of positioning the liquid crystal panel and preventing the liquid crystal panel from coming off can be achieved.

In order to achieve the above object of providing a liquid crystal display, another liquid crystal display is further provided by the present invention. The liquid crystal display comprises a liquid crystal panel, a front frame, a middle frame, a rear frame, an optical element and a positioning bump, wherein the liquid crystal panel comprises a front side and a back side opposite the front side. The positioning bump is connected with the back side of the liquid crystal panel. A supporting portion is extended from an inner side of the middle frame. A positioning hole is disposed on an upper part of the supporting portion. The supporting portion is used for supporting the liquid crystal panel and the positioning bump is inserted into the positioning hole. The rear frame is disposed on the inner side of the middle frame and under the supporting portion. The front frame is disposed on an outer side of the middle frame and on the front side of the liquid crystal panel. And the optical element is disposed between an inner side of the rear frame and the supporting portion, wherein the optical element includes a reflective film, a light guide plate, a diffuser film, a prism film, a brightness enhancement film and so on. The adhesive material is a heat-fusing adhesive.

A technique employed by the present invention to achieve the above object is to insert the positioning bump on the back side of the liquid crystal panel into the positioning hole of the middle frame. Thereby, the object of positioning the liquid crystal panel and preventing the liquid crystal panel from coming off can be achieved.

The structural design of the above liquid crystal display is favorable for assembling and enhancing the manufacturing efficiency and the requirement for the narrow frame design can also be achieved.

### BRIEF DESCRIPTION OF THE DRAWINGS

FIG. 1 is a section view of an assembling structure of a liquid crystal display of a conventional technique;

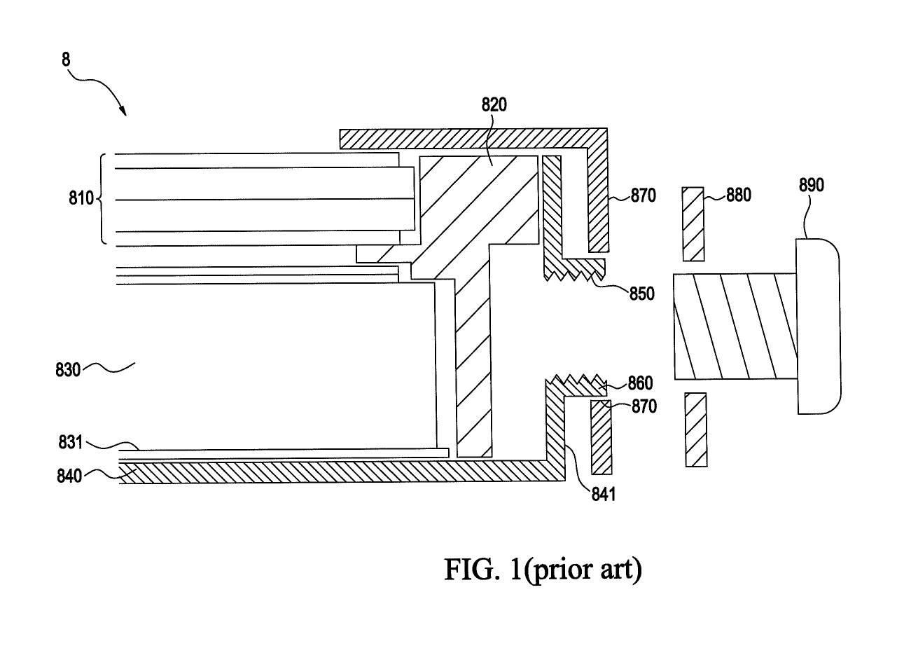

FIG. 2 is a section view of an assembling structure of another liquid crystal display of a conventional technique;

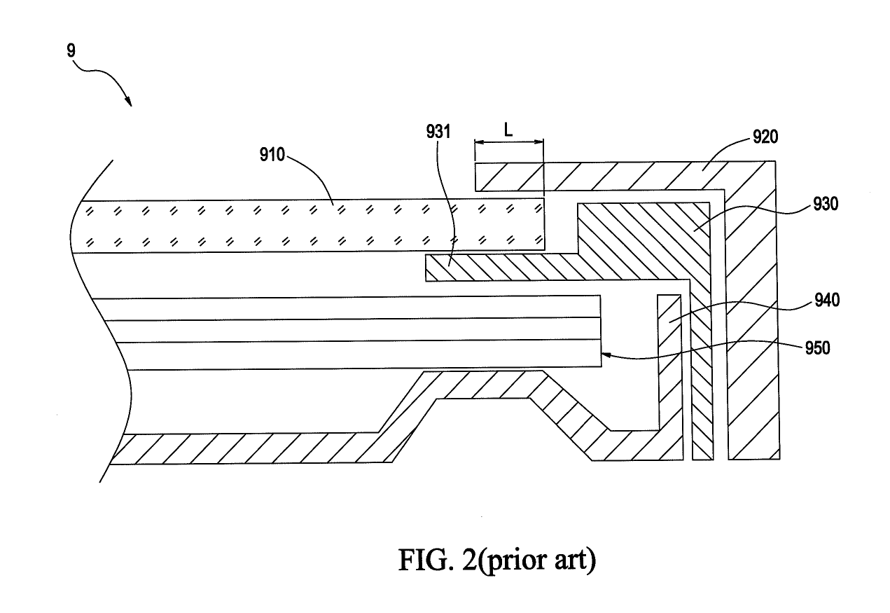

FIG. 3 is a section view of an assembling structure of a liquid crystal display according to a first embodiment of the present invention; and

FIG. 4 is a section view of an assembling structure of a liquid crystal display according to a second embodiment of the present invention.

### DETAILED DESCRIPTION OF THE INVENTION

The present invention will become more fully understood by reference to the following detailed description thereof when read in conjunction with the accompanying drawings.

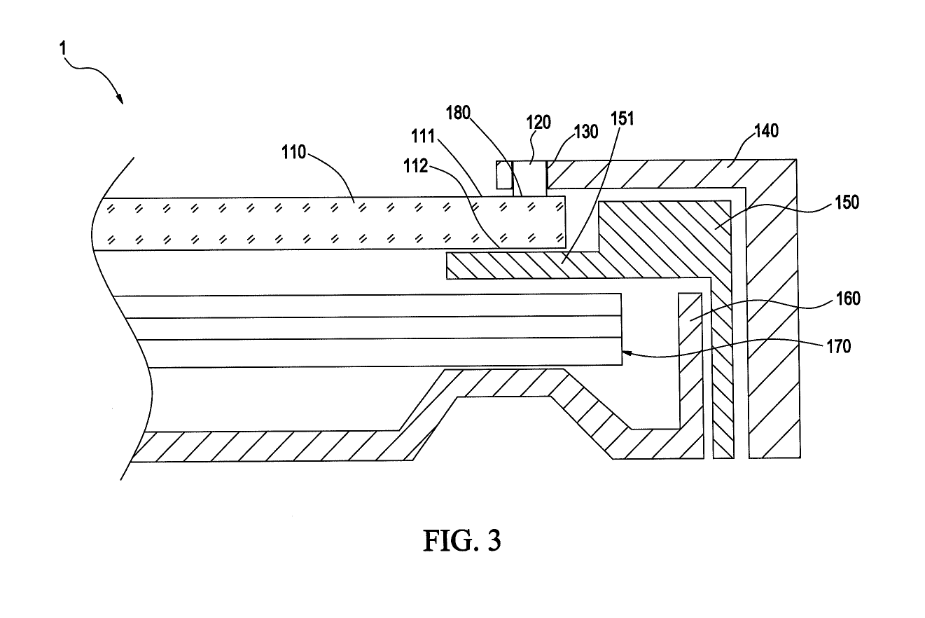

FIG. 3 is a section view of an assembling structure of a liquid crystal display according to a first embodiment of the present invention. A liquid crystal display 1 comprises a liquid crystal panel 110, a front frame 140, a middle frame 150, a rear frame 160, an optical element 170 and a positioning bump 120. The liquid crystal panel 110 comprises a front side 111 and a back side 112 disposed oppositely to the front side 111. The positioning bump 120 is connected with the front side 111 of the liquid crystal panel 110 by an adhesive material 180. A supporting portion 151 is extended from an inner side of the middle frame 150. An upper part of the supporting portion 151 is used for supporting the liquid crystal panel 110 and is connected with the back side 112 of the liquid crystal panel 110. The rear frame 160 is disposed on the inner side of the middle frame 150 and under the supporting portion 151. The front frame 140 comprises a positioning hole 130. The positioning hole 130 can be a groove or a through hole. The front frame 140 is disposed on an outer side of the middle frame 150. The positioning bump 120 is inserted into the positioning hole 130. Thereby, the object of positioning the liquid crystal panel 110 and preventing the liquid crystal panel 110 from coming off can be achieved. The optical element 170 is disposed between an inner side of the rear frame 160 and the supporting portion 151. The optical element 170 includes a reflective film, a light guide plate, a diffuser film, a prism film, a brightness enhancement film and so on. The adhesive material 150 is a heat-fusing adhesive.

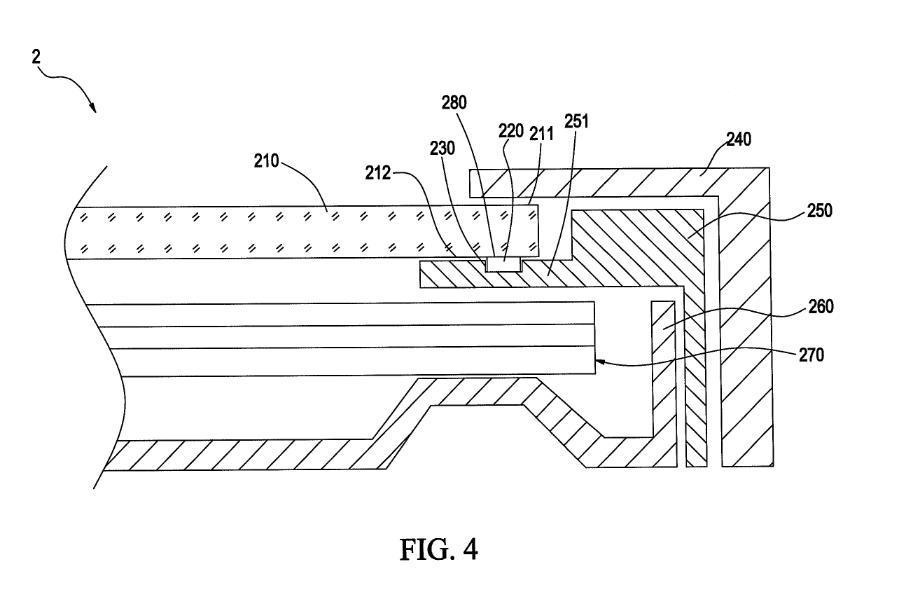

FIG. 4 is a section view of an assembling structure of a liquid crystal display according to a second embodiment of the present invention. A liquid crystal display 2 comprises a liquid crystal panel 210, a front frame 240, a middle frame 250, a rear frame 260, an optical element 270 and a positioning bump 220. The liquid crystal panel 210 comprises a front side 211 and a back side 212 disposed oppositely to the front side 211. The positioning bump 220 is connected with the back side 212 of the liquid crystal panel 210 by an adhesive material 280. A supporting portion 251 is extended from an inner side of the middle frame 250. A positioning hole 230 is disposed on an upper part of the supporting portion 251. The positioning hole 230 can be a groove or a through hole. The supporting portion 251 is used for supporting the liquid crystal panel 210 and the positioning bump 220 is inserted into the positioning hole 230. Thereby, the object of positioning the liquid crystal panel 210 and preventing the liquid crystal panel 210 from coming off can be achieved. The rear frame 260 is disposed on the inner side of the middle frame 250 and under the supporting portion 251. The front frame 240 is disposed on an outer side of the middle frame 250 and on the front side 211 of the liquid crystal panel 210. The optical element 270 is disposed between an inner side of the rear frame 260 and the supporting portion 251. The optical element 270 includes a reflective film, a light guide plate, a diffuser film, a prism film, a brightness enhancement film and so on. The adhesive material 280 is a heat-fusing adhesive.

The structural design of the above liquid crystal display is favorable for assembling and enhancing the manufacturing efficiency and the requirement for the narrow frame design can also be achieved.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A securing device of a liquid crystal panel for connecting with a rear frame comprising:
a liquid crystal panel comprising a front side and a back side opposite to the front side;
a positioning bump connected with the front side;
a middle frame, wherein a supporting portion is extended from an inner side of the middle frame, an upper part of the supporting portion is used for supporting the liquid crystal panel and being connected with the back side of the liquid crystal panel, the rear frame is disposed on the inner side of the middle frame and under the supporting portion; and
a front frame comprising a positioning hole, wherein the front frame is disposed on an outer side of the middle frame, the positioning bump is inserted into the positioning hole.

2. The securing device of claim 1, further comprising an adhesive material, wherein the adhesive material is used for connecting the positioning bump and the front side of the liquid crystal panel.

3. The securing device of claim 1, further comprising an optical element disposing between an inner side of the rear frame and the supporting portion.

4. A securing device of a liquid crystal panel for connecting with a rear frame comprising:
a liquid crystal panel comprising a front side and a back side disposed oppositely to the front side;
a positioning bump connected with the back side;
a middle frame, wherein a supporting portion is extended from an inner side of the middle frame, a positioning hole is disposed on an upper part of the supporting portion, the supporting portion is used for supporting the liquid crystal panel and the positioning bump is inserted into the positioning hole, the rear frame is disposed on the inner side of the middle frame and under the supporting portion; and
a front frame disposed on an outer side of the middle frame and on the front side of the liquid crystal panel.

5. The securing device of claim 4, further comprising an adhesive material, wherein the adhesive material is used for connecting the positioning bump and the back side of the liquid crystal panel.

6. The securing device of claim 4, further comprising an optical element disposing between an inner side of the rear frame and the supporting portion.

7. A liquid crystal display comprising:
a liquid crystal panel comprising a front side and a back side disposed oppositely to the front side;
a positioning bump connected with the front side;
a middle frame, wherein a supporting portion is extended from an inner side of the middle frame, an upper part of the supporting portion is used for supporting the liquid crystal panel and is connected with the back side of the liquid crystal panel, the rear frame is disposed on the inner side of the middle frame and under the supporting portion;
a front frame comprising a positioning hole, wherein the front frame is disposed on an outer side of the middle frame, the positioning bump is inserted into the positioning hole; and
an optical element disposing between an inner side of the rear frame and the supporting portion.

8. The liquid crystal display of claim 7, further comprising an adhesive material, wherein the adhesive material is used for connecting the positioning bump and the front side of the liquid crystal panel.

9. A liquid crystal display comprising:
a liquid crystal panel comprising a front side and a back side disposed oppositely to the front side;
a positioning bump connected with the back side;
a middle frame, wherein a supporting portion is extended from an inner side of the middle frame, a positioning hole is disposed on an upper part of the supporting portion, the supporting portion is used for supporting the liquid crystal panel and the positioning bump is inserted into the positioning hole, the rear frame is disposed on the inner side of the middle frame and under the supporting portion;
a front frame disposed on an outer side of the middle frame and on the front side of the liquid crystal panel; and
an optical element disposing between an inner side of the rear frame and the supporting portion.

10. The liquid crystal display of claim 9, further comprising an adhesive material, wherein the adhesive material is used for connecting the positioning bump and the back side of the liquid crystal panel.
